(19) United States
(12) Patent Application Publication
(10) Pub. No.: US 2011/0233312 A1
(43) Pub. Date: Sep. 29, 2011

(54) PERFUME BOTTLE SPRAY CONTROL MECHANISM

(76) Inventor: Chuan-Wei Ko, Chung-Li (TW)

(21) Appl. No.: 12/748,395

(22) Filed: Mar. 27, 2010

(51) Int. Cl. B05B 1/00

(52) U.S. Cl. 239/589

(57) ABSTRACT

A perfume bottle spray control mechanism is disclosed to include a body formed of a housing, which has a locating hole on the top wall thereof, and a stem, which is rotatably mounted in the housing and has a top connection stem portion thereof suspending outside the housing, a switching plate, which is attached to the stem outside the housing and operable to rotate the stem in the housing and has an arched guide slot cut through the top and bottom walls thereof corresponding to the locating hole of the housing, and a nozzle head, which includes a casing coupled to the top connection stem portion of the stem above the switching plate and having a bottom locating rod inserted through the arched guide slot of the switching plate and fastened to the locating hole of the housing.

### BACKGROUND OF THE INVENTION

1. Field of the Invention

The present invention relates to perfume sprayers and more particularly, to a perfume bottle spray control structure for perfume sprayer, which uses switching plate to control close/open of the perfume passage, facilitating perfume application and preventing perfume leakage during storage or transportation of the perfume sprayer.

2. Description of the Related Art

In a regular spray type perfume bottle, the perfume passage is closed or opened by means of rotating the spray head. However, when using a spray type perfume bottle, the user must compress the inflation bulb that is connected to the spray head. When the user operates the inflation bulb, the spray head may be biased to shut off the perfume passage accidentally, interfering with perfume application. Further, the inflation bulb has a big dimension and is connected to the nozzle head on the outside. When the spray type perfume bottle is not in use and received in a bag or storage box, the inflation bulb may be biased accidentally, causing rotation of the nozzle head and opening of the perfume passage and further perfume leakage.

Therefore, it is desirable to provide a perfume spray control mechanism for perfume sprayer that eliminates the aforesaid problems.

### SUMMARY OF THE INVENTION

The present invention has been accomplished under the circumstances in view. It is one object of the present invention to provide a perfume bottle spray control mechanism for perfume sprayer, which uses switching plate to control close/open of the perfume passage, facilitating perfume application and preventing perfume leakage during storage or transportation of the perfume sprayer.

To achieve this and other objects of the present invention, a perfume bottle spray control mechanism comprises a body, which comprises a housing having a locating hole located on the top wall thereof near the border and a stem rotatably mounted in the housing, a switching plate attached to the stem and supported on the top wall of the housing for operation by a user to rotate the stem in the housing, and a nozzle head, which has a casing coupled to the stem above the switching plate and a locating rod downwardly extended from the bottom wall of the casing and inserted through an arched guide slot on the switching plate and firmly positioned in the locating hole of the housing to avoid rotation of the nozzle head with the switching plate.

### BRIEF DESCRIPTION OF THE DRAWINGS

FIG. 1 is an elevational view of a perfume bottle spray control mechanism for perfume sprayer according to the present invention.

FIG. 2 is an exploded view of the perfume bottle spray control mechanism according to the present invention.

FIG. 3 is a sectional side view of the perfume bottle spray control mechanism according to the present invention.

FIG. 4 is a schematic sectional top view of the present invention, showing the switching plate rotated relative to the housing of the body.

FIG. 5 is a schematic sectional top view of the present invention, showing the switching plate switched to the open position.

FIG. 6 is a schematic sectional top view of the present invention, showing the switching plate switched to the close position.

FIG. 7 is an applied view of the present invention, showing the perfume bottle spray control mechanism installed in a perfume bottle.

FIG. 8 is a schematic sectional view of an alternate form of the present invention.

### DETAILED DESCRIPTION OF THE PREFERRED EMBODIMENT

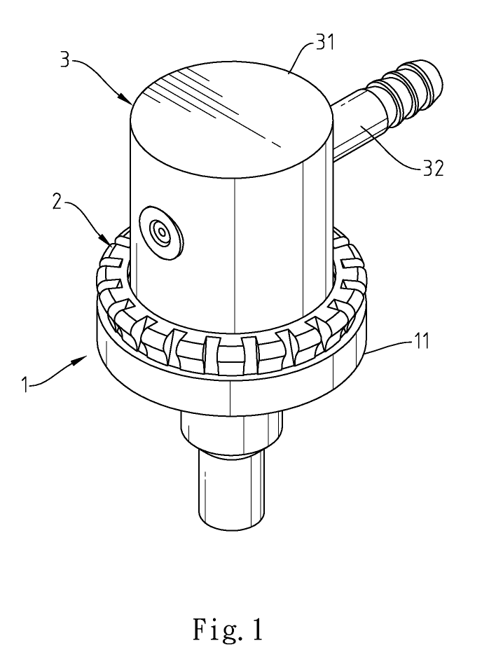

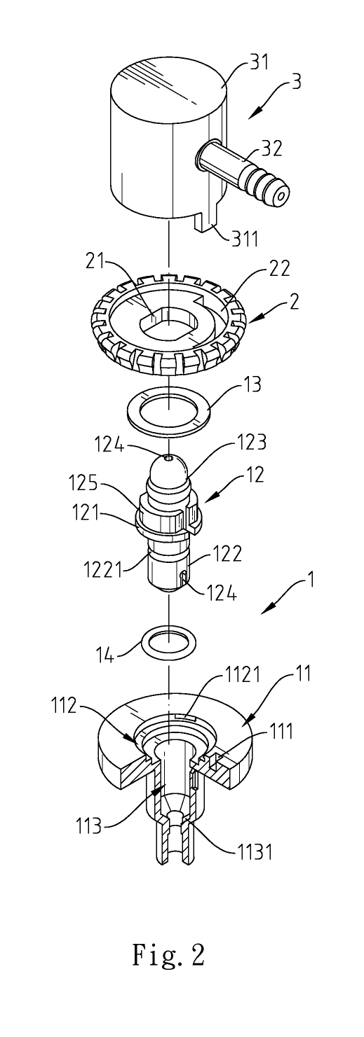

Referring to FIGS. 1-3, a perfume bottle spray control mechanism in accordance with the present invention is shown comprising a body 1, a switching plate 2 and a nozzle head 3.

The body 1 comprises housing 11, a stem 12, an annular locating plate 13 and a gasket ring 14. The housing 11 has a center recess 112 located on the top wall thereof, a locating hole 111 located on the top wall adjacent to the border of the center recess 112, a coupling hole 113 axially downwardly extended from the center recess 112, an inside groove 1131 disposed inside the coupling hole 113 and a plurality of locating protrusions 1121 equiangularly spaced around the inside wall of the center recess 112. The stem 12 has a bottom coupling stem portion 122 and a top connection stem portion 123 axially aligned in line, a collar 121 extending around the periphery thereof between the bottom coupling stem portion 122 and the top connection stem portion 123, a through hole 124 axially extending through the top connection stem portion 123 and a part of the bottom coupling stem portion 122 and then turned at right angle through the periphery of the bottom coupling stem portion 122, a polygonal transmission portion 125 located on the periphery of the top connection stem portion 123 adjacent to the collar 121 and a locating groove 1221 extending around the periphery of the bottom coupling stem portion 122.

The switching plate 2 has a non-circular center coupling hole 21 cut through the top and bottom walls thereof at the center and an arched guide slot 22 cut through the top and bottom walls and extending around the center coupling hole 21.

The nozzle head 3 has a casing 31, a nozzle tube 32 transversely extended out of the periphery of the casing 31 and a locating rod 311 vertically downwardly extended from the bottom wall of the casing 31 in flush with the periphery of the casing 31.

Referring to FIGS. 1-3 again, the assembly process of the perfume bottle spray control mechanism of the present invention is quite simple. During the assembly process, attach the gasket ring 14 to the locating groove 1221 of the stem 12, and then insert the bottom coupling stem portion 122 of the stem 12 downwardly into the coupling hole 113 of the housing 11 to rest the collar 121 in the center recess 112, and then sleeve the annular locating plate 13 onto the stem 12 for enabling the annular locating plate 13 to be supported on the collar 121 around the transmission portion 125 and stopped below the locating protrusions 1121 to prohibit backward (upward) displacement of the stem 12 relative to the housing 11. At this time, the top connection stem portion 123 of the stem 12 protrudes over the top side of the housing 11. Thereafter, couple the non-circular center coupling hole 21 of the switching plate 2 to the polygonal transmission portion 125 at the top connection stem portion 123 of the stem 12 to let the switching plate 2 to be supported on the top side of the housing 11 and the arched guide slot 22 be aimed at the locating hole 111 of the housing 11. Thereafter, connect the casing 31 of the nozzle head 3 to the top connection stem portion 123 of the stem 12 above the switching plate 2 to force the locating rod 311 through the arched guide slot 22 into the locating hole 111. Thus, the perfume bottle spray control mechanism is assembled.

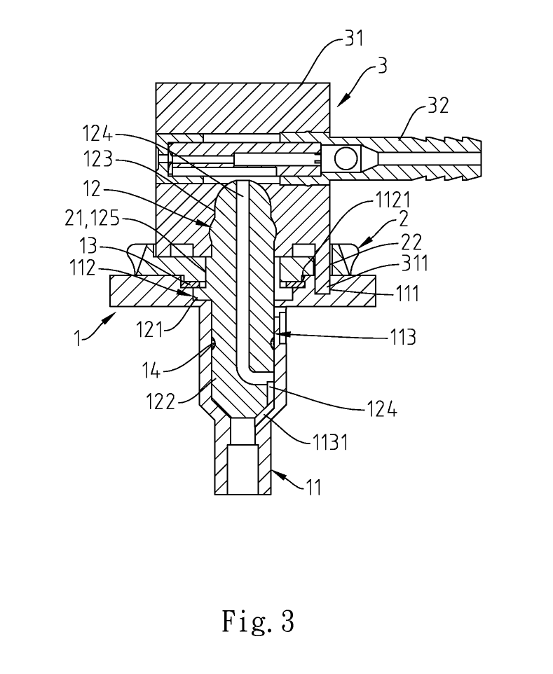

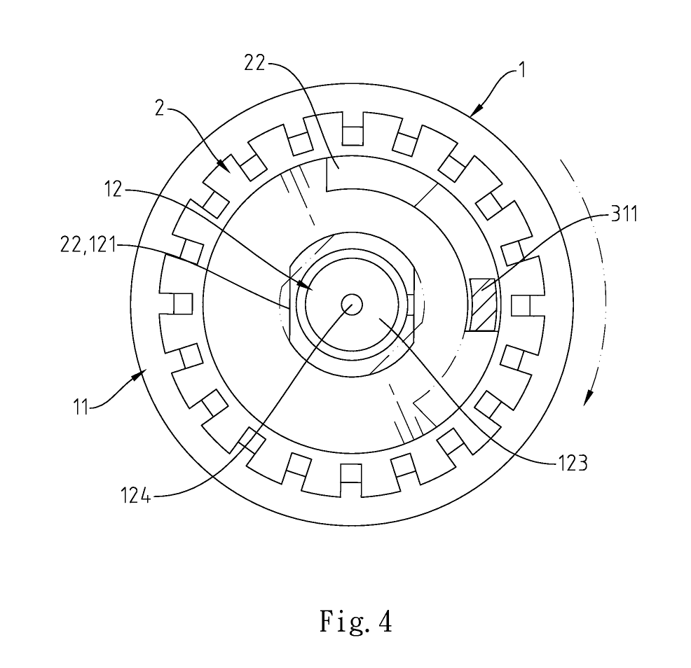

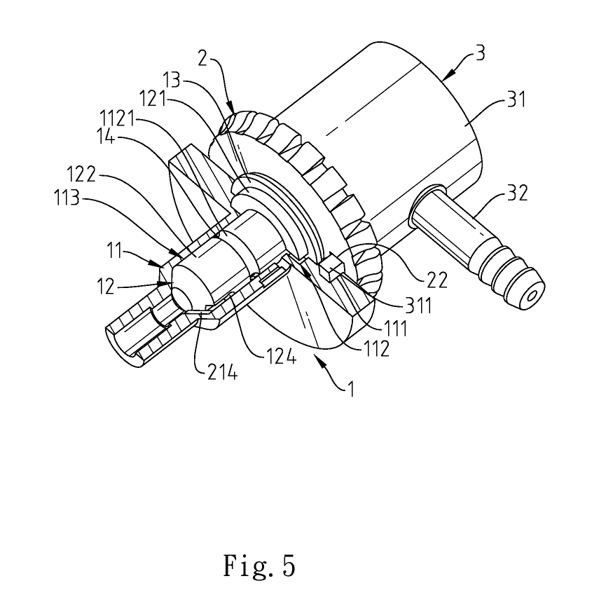

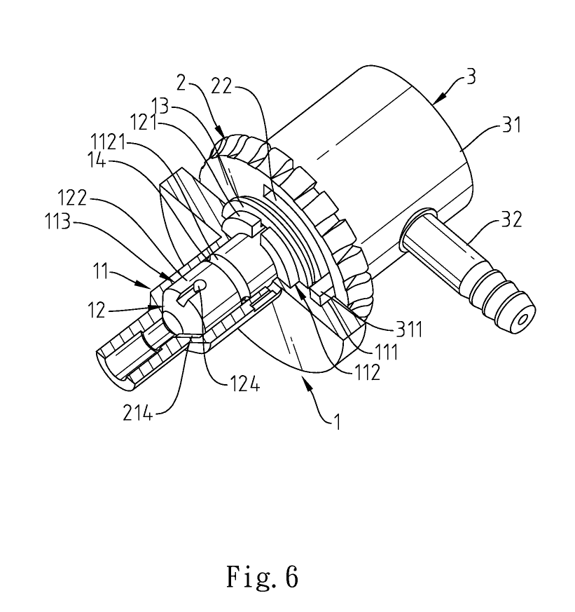

Referring to FIGS. 4˜6 and FIG. 3 again, when rotating the switching plate 2, the stem 12 is rotated with the switching plate 2. However, because the locating rod 311 is inserted through the arched guide slot 22 and positioned in the locating hole 111, the angle of rotation of the switching plate 2 is constrained to a limited angle by the arched guide slot 22, i.e., the switching plate 2 is rotatable between two limit points (see FIG. 4). Further, when the user operates the switching plate 2 in one direction to rotate the stem 12 to one limit point, the end of the through hole 124 at the bottom coupling stem portion 122 of the stem 12 is kept in communication with the inside groove 1131 (see FIG. 5). On the contrary, when the user operates the switching plate 2 to rotate the stem 12 in the reversed direction to the other limit point, the end of the through hole 124 at the bottom coupling stem portion 122 of the stem 12 is kept away from the inside groove 1131 and blocked by the inside wall of the housing 11 (see FIG. 3 and FIG. 6). Because the angle of rotation of the switching plate 2 is controlled by the arched guide slot 22, the user can rotate the switching plate 2 to open or close the passage between the through hole 124 and the inside groove 1131 accurately.

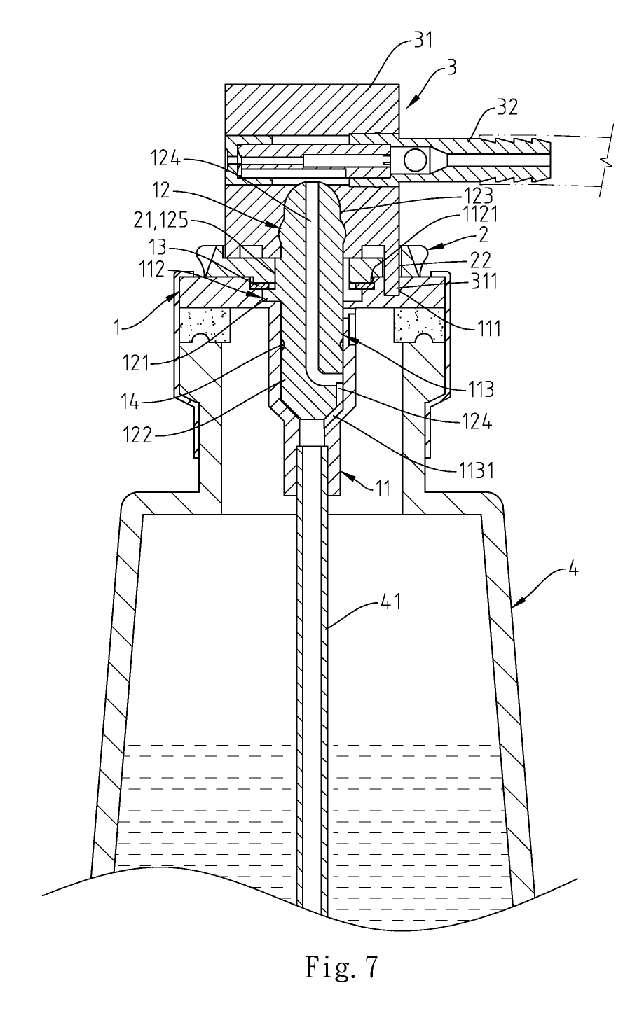

Referring to FIG. 7, during application of the perfume bottle spray control mechanism, the housing 11 is attached to a perfume bottle 4, a dip tube 41 is fastened to the coupling hole 113 of the housing 11 and suspending inside the perfume bottle 4, and an inflation bulb 5 (not shown) is fastened to one end of the nozzle tube 32 of the nozzle head 3. After installation, the user can rotate the switching plate 2 to turn on/off the passage between the through hole 124 and the inside groove 1131. When the passage between the through hole 124 and the inside groove 1131 is opened, the user can compress the inflation bulb 5, causing a certain amount of the contained perform to be sucked by the dip tube 41 through the inside groove 1131 and the through hole 124 into the inside of the nozzle tube 32 and then carried by the forced air out of the nozzle head 3 for application. Because the locating rod 311 of the nozzle head 3 is inserted through the arched guide slot 22 and positioned in the locating hole 111 and because the passage between the through hole 124 and the inside groove 1131 is controlled by the switching plate 2, operating the inflation bulb 5 does not cause rotation of the switching plate 2 accidentally.

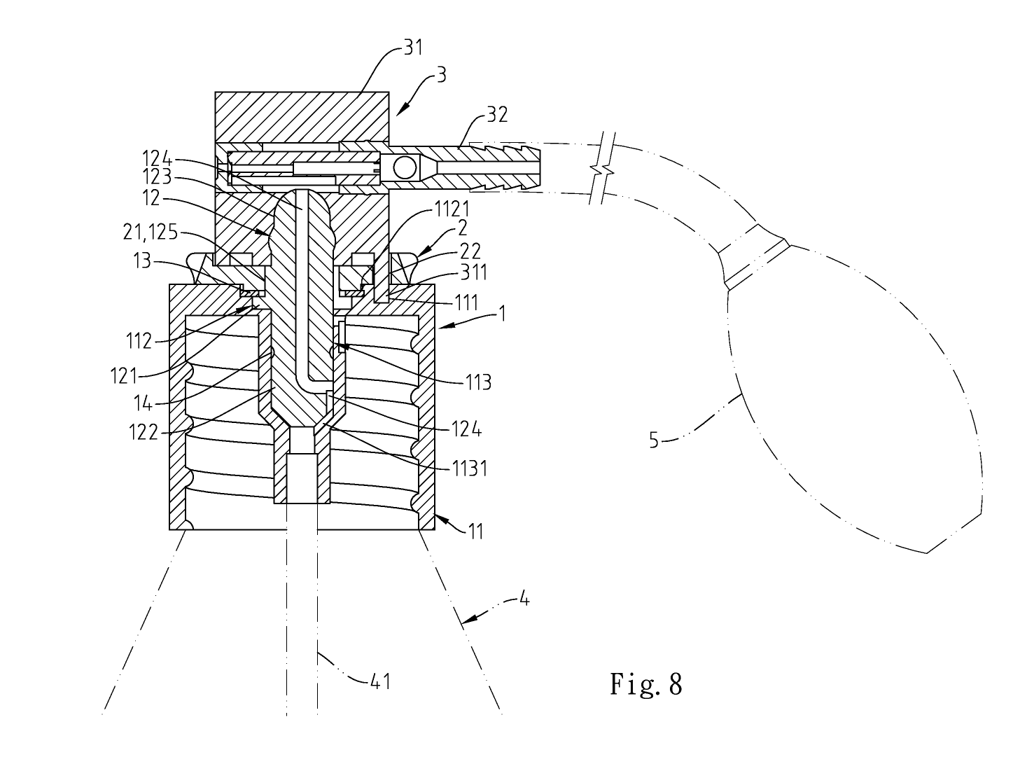

FIG. 8 shows an alternate form of the present invention. This alternate form is substantially similar to that shown in FIGS. 1˜7 with the exception of the mounting arrangement between the housing 11 and the perfume bottle 4. However, because the mounting arrangement between the housing 11 and the perfume bottle 4 is not within the scope of the claims of the present invention, no further detailed description in this regard is necessary.

In conclusion, the invention provides a perfume bottle spray control mechanism, which is characterized by the use of the switching plate 2 to control on/off of the perfume passage, preventing accidental perfume passage shutoff during its application, and also characterized by the arrangement of the switching plate 2 between the housing 11 and the nozzle head 3 to facilitate storage of the perfume sprayer and to prevent accidental opening of the perfume passage due to accidental stretching of the inflation bulb 5.

Although particular embodiments of the invention have been described in detail for purposes of illustration, various modifications and enhancements may be made without departing from the spirit and scope of the invention.

What the invention claimed is:

1. A perfume bottle spray control mechanism, comprising:
a body, said body comprising a housing, said housing comprising a locating hole located on a top wall thereof and disposed near the border thereof, and a stem rotatably mounted in said housing, said stem comprising a top connection stem portion suspending outside said housing;
a switching plate attached to said stem and supported on the top wall of said housing and operable to rotate said stem in said housing, said switching plate having an arched guide slot cut through top and bottom walls thereof corresponding to said locating hole of said housing; and
a nozzle head, said nozzle head comprising a casing coupled to said top connection stem portion of said stem above said switching plate, said casing having a locating rod downwardly extended from a bottom wall thereof and inserted through said arched guide slot of said switching plate and firmly positioned in said locating hole of said housing, and a nozzle tube transversely mounted in and extending out of said casing.

2. The perfume bottle spray control mechanism as claimed in claim 1, wherein said housing further comprises a center recess located on the top wall thereof at the center and a coupling hole axially downwardly extended from said center recess; said stem further comprises a bottom coupling stem portion axially connected to said top connection stem portion in line and inserted into said coupling hole of said housing, a collar extended around the periphery thereof between said top connection stem portion and said bottom coupling stem portion and rest in said center recess of said housing.

3. The perfume bottle spray control mechanism as claimed in claim 2, wherein said housing further comprises a plurality of locating protrusions equiangularly spaced around an inside wall of said center recess; said stem is mounted with a locating plate, said locating late being stopped between said collar and said locating protrusions.

4. The perfume bottle spray control mechanism as claimed in claim 2, wherein said housing further comprises an inside groove located on an inside wall of said coupling hole; said stem further comprises a through hole axially cutting through said top connection stem portion and transversely extending out of the periphery of a middle part of said bottom coupling stem portion for communication with said inside groove when said stem is rotated with said switching plate to a predetermined angle.

5. The perfume bottle spray control mechanism as claimed in claim 1, wherein said stem further comprises a transmission portion extending around the periphery thereof; said switching plate comprises a polygonal coupling hole cutting through top and bottom walls thereof and coupled to said transmission portion of said stem.
